(19) United States
(12) Patent Application Publication
(10) Pub. No.: US 2003/0185415 A1
(43) Pub. Date: Oct. 2, 2003

(54) Speaker

(76) Inventors: Osamu Funahashi, Osaka (JP); Hiroyuki Morimoto, Mie (JP); Yukio Okamoto, Aichi (JP)

Correspondence Address: WENDEROTH, LIND & PONACK, L.L.P., 2033 K STREET N. W., SUITE 800, WASHINGTON, DC, 20006-1021, US

(21) Appl. No.: 10/333,960

(22) PCT Filed: Jun. 10, 2002
(86) PCT No.: PCT/JP02/05722

(30) Foreign Application Priority Data
Jun. 11, 2001 (JP) 2001-175149
Apr. 15, 2002 (JP) 2002-111717

(51) Int. Cl. H04R 1/00; H04R 9/06; H04R 11/02

(52) U.S. Cl. 381/398; 381/407; 381/423

(57) ABSTRACT

A high efficiency loudspeaker without a damper is provided. The loudspeaker includes magnetic circuit 9 having magnetic gap 14 and voice coil member 15, which has movable coil 16, disposed in magnetic gap 14 of magnetic circuit 9. The loudspeaker also includes diaphragm 17, whose inner peripheral part is linked with voice coil member 15, outside magnetic gap 14 and frame 19 linked with an outer peripheral part of diaphragm 17 via first edge 18. An inner peripheral part of suspension holder 20 is linked with voice coil member 15 at a linked position, which is nearer to magnetic circuit 9 than a linked position of diaphragm 17 and voice coil member 15. An outer peripheral part of suspension holder 20 is linked with frame 19 via second edge 21. First edge 18 and second edge 21 are substantially symmetrical analog each other about a median of first edge 18 and second edge 21.

### TECHNICAL FIELD

The present invention relates to a loudspeaker.

### BACKGROUND ART

FIG. 22 shows a structure of a conventional loudspeaker.

As shown in FIG. 22, the conventional loudspeaker includes magnetic circuit 1, voice coil member 4, diaphragm 5 and frame 7. Voice coil member 4, which has movable coil 3, is disposed in magnetic gap 2 of magnetic circuit 1. An inner peripheral part of diaphragm 5 is linked with voice coil member 4, outside magnetic gap 2. An outer peripheral part of diaphragm 5 is linked with frame 7 via edge 6. An electric signal, which is supplied from an audio amplifier and the like, is input to coil 3 of voice coil member 4, and then voice coil member 4 is excited. As a result, force is transmitted to diaphragm 5, then diaphragm 5 vibrates air, thereby changing the electric signal into voice.

As shown in FIG. 22, an inner peripheral part of damper 8 is fixed between voice coil 3 of voice coil member 4 and a fixed point of the inner peripheral part of diaphragm 5. An outer peripheral part of damper 8 is fixed at frame 7. Damper 8 and edge 6 form a suspension, and prevent voice coil member 4 from rolling in working. As shown in FIG. 22, damper 8 is formed of a plurality of wave shapes for reducing a mechanical load of voice coil member 4.

In this structure mentioned above, in working of voice coil member 4 toward magnetic circuit 1 and working of voice coil member 4 toward an opposite side of magnetic circuit 1, non-linearity and asymmetry of a mechanical load of damper 8 becomes large. As a result, large harmonic distortion occurs, and power linearity deteriorates. FIG. 23 shows amplitude of diaphragm 5 vs. input electric power of the loudspeaker, namely power linearity of a conventional loudspeaker having damper 8. Curve A shows an amplitude characteristic of diaphragm 5 toward magnetic circuit 1, and curve B shows an amplitude characteristic of diaphragm 5 toward an opposite side of magnetic circuit 1. FIG. 24 shows an harmonic distortion characteristic of the conventional loudspeaker having damper 8, where curve C shows output sound pressure of the loudspeaker, curve D shows the second harmonic distortion characteristic and curve E shows the third harmonic distortion characteristic. As mentioned above, damper 8 is formed of a plurality of wave shapes for reducing a mechanical load of voice coil member 4, and damper 8 and edge 6 form a suspension. As a result, the conventional loudspeaker is difficult to improve non-linearity and asymmetry, so that harmonic distortion is not reduced.

### SUMMARY OF THE INVENTION

A loudspeaker includes the following elements:

(a) a magnetic circuit including a magnetic gap,

(b) a voice coil member disposed in the magnetic gap of the magnetic circuit and having a movable coil,

(c) a diaphragm whose inner peripheral part is linked with the voice coil member, outside the magnetic gap, and

(d) a frame linked with an outer peripheral part of the diaphragm via a first edge,

where an inner peripheral part of a suspension holder is linked with the voice coil member at a linked position, which is nearer to the magnetic circuit than the linked position of the diaphragm and the voice coil member,

where an outer peripheral part of the suspension holder is linked with the frame via a second edge,

where the first edge and the second edge are substantially symmetrical analog each other about a median of the first edge and the second edge.

The structure mentioned above does not need a damper, thereby providing a loudspeaker for solving the problems of non-linearity and asymmetry of a suspension.

### BRIEF DESCRIPTION OF THE DRAWINGS

FIG. 1 is a sectional view of a loudspeaker in accordance with a first exemplary embodiment of the present invention.

FIG. 2 is a graph showing a characteristic of power linearity of the loudspeaker in accordance with the first embodiment of the invention.

FIG. 3 is a graph showing a characteristic of harmonic distortion of the loudspeaker in accordance with the first embodiment of the invention.

FIG. 4 is a sectional view of a loudspeaker in accordance with a second exemplary embodiment of the present invention.

FIG. 5 is a sectional view of a loudspeaker in accordance with a third exemplary embodiment of the present invention.

FIG. 6 is a sectional view of a loudspeaker in accordance with a fourth exemplary embodiment of the present invention.

FIG. 7 is a sectional view of a loudspeaker in accordance with a fifth exemplary embodiment of the present invention.

FIG. 8 is a sectional view of a loudspeaker in accordance with a sixth exemplary embodiment of the present invention.

FIG. 9 is a sectional view of a loudspeaker in accordance with a seventh exemplary embodiment of the present invention.

FIG. 10 is a sectional view of a loudspeaker in accordance with a eighth exemplary embodiment of the present invention.

FIG. 11 is a sectional view of a loudspeaker in accordance with a ninth exemplary embodiment of the present invention.

FIG. 12 is a sectional view of a loudspeaker in accordance with a tenth exemplary embodiment of the present invention.

FIG. 13 is a sectional view of a loudspeaker in accordance with a eleventh exemplary embodiment of the present invention.

FIG. 14 is a sectional view of a loudspeaker in accordance with a twelfth exemplary embodiment of the present invention.

FIG. 15 is a sectional view of a loudspeaker in accordance with a thirteenth exemplary embodiment of the present invention.

FIG. 16 is a sectional view of a loudspeaker in accordance with a fourteenth exemplary embodiment of the present invention.

FIG. 17 is a sectional view of a loudspeaker in accordance with a fifteenth exemplary embodiment of the present invention.

FIG. 18 is a rear view of a loudspeaker in accordance with a sixteenth exemplary embodiment of the present invention.

FIG. 19 is a partially cutaway front view of a loudspeaker in accordance with a seventeenth exemplary embodiment of the present invention.

FIG. 20 is a partially cutaway sectional view of a loudspeaker in accordance with a eighteenth exemplary embodiment of the present invention.

FIG. 21 is a sectional view of a loudspeaker in accordance with a nineteenth exemplary embodiment of the present invention.

FIG. 22 is a sectional view of a conventional loudspeaker.

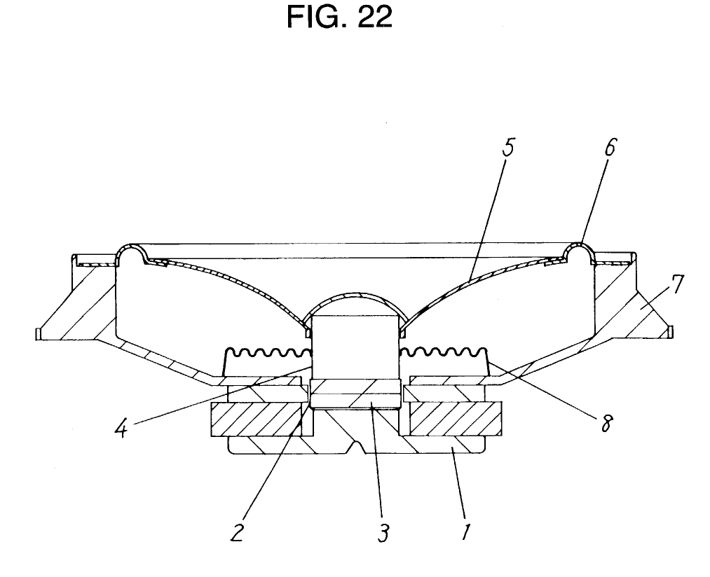

FIG. 23 is a graph showing a characteristic of power linearity of the conventional loudspeaker.

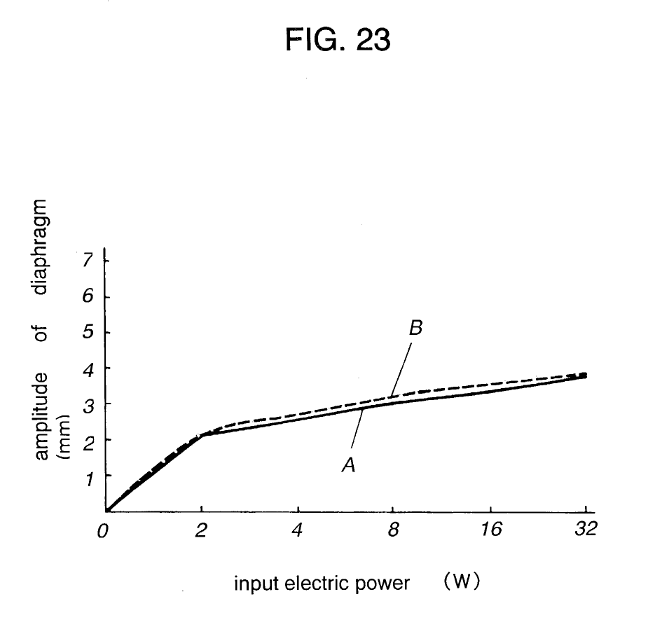

FIG. 24 is a graph showing a characteristic of harmonic distortion of the conventional loudspeaker.

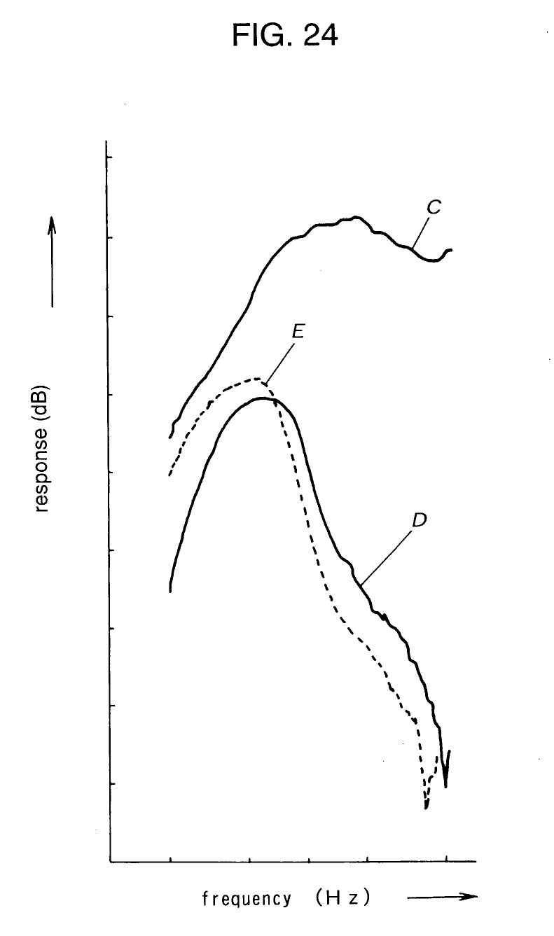

### DETAILED DESCRIPTION OF THE PREFERRED EMBODIMENTS

Exemplary embodiments of the present invention are described hereinafter with reference to drawings,, which are schematic ones, and do not show correct dimensional relations between respective elements.

### First Exemplary Embodiment

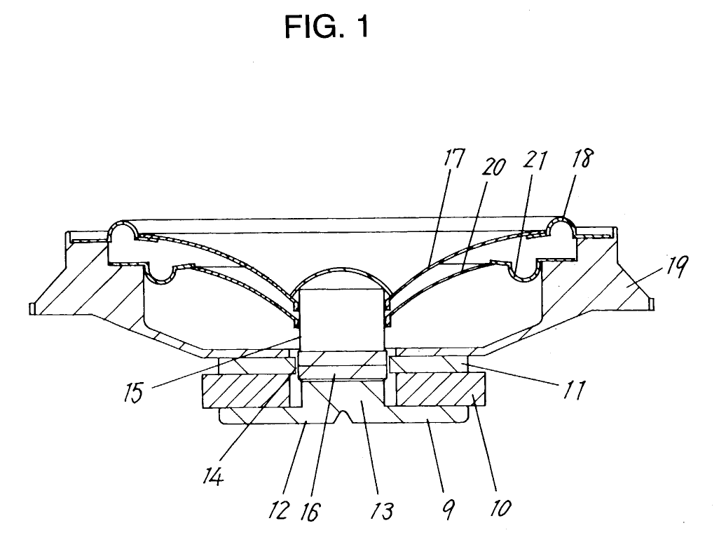

FIG. 1 is a sectional view of a loudspeaker in accordance with the first exemplary embodiment of the present invention. Magnetic circuit 9 is formed of ring-shaped magnet 10, ring-shaped plate 11, disk-shaped yoke 12 and columnar pole 13. Magnetic flux of magnet 10 is concentrated in magnetic gap 14 between an inner peripheral part of plate 11 and an outer peripheral part of pole 13.

Ferromagnetic material such as ferrite base magnet, rare-earth cobalt base magnet, neodymium base magnet is used as magnet 10, and soft magnetic material such as iron is used as plate 11, yoke 12 or pole 13. In this invention, the magnetic circuit of outer magnet type is shown in FIG. 1, however, a magnetic circuit of inner magnet type can be also used.

Cylindrical voice coil member 15 has movable coil 16 in magnetic gap 14 of magnetic circuit 9, and is formed of a bobbin where a coil such as copper wire is wound. The bobbin is made of material such as paper, resin or metal.

An inner peripheral part of substantially inverted cone shape diaphragm 17 is linked with voice coil member 15, outside magnetic gap 14. Diaphragm 17 is made of material such as pulp or resin, which is light and has high stiffness and moderate internal loss, and used for making a sound by vibration excited with voice coil member 15. Ring-shaped first edge 18 is connected with an outer peripheral part of diaphragm 17, and made of material such as urethane, rubber or cloth for reducing a mechanical load of diaphragm 17.

Frame 19, which has a disk shape, is linked with an outer peripheral part of diaphragm 17 via first edge 18. Frame 19 is made of material formed by iron pressing, resin molding or aluminum die-casting method, so that a complicated shape can be produced. An inner peripheral part of suspension holder 20 is linked with voice coil member 15 at a linked position, which is nearer to magnetic circuit 9 than a linked position of diaphragm 17 and voice coil member 15. Suspension holder 20 is made of material such as pulp or resin, which is light and has high stiffness and large internal loss. An outer peripheral part of suspension holder 20 is coupled with frame 19 via second edge 21. Second edge 21 is made of the same material as first edge 18 such as urethane, rubber or cloth for reducing a mechanical load of suspension holder 20.

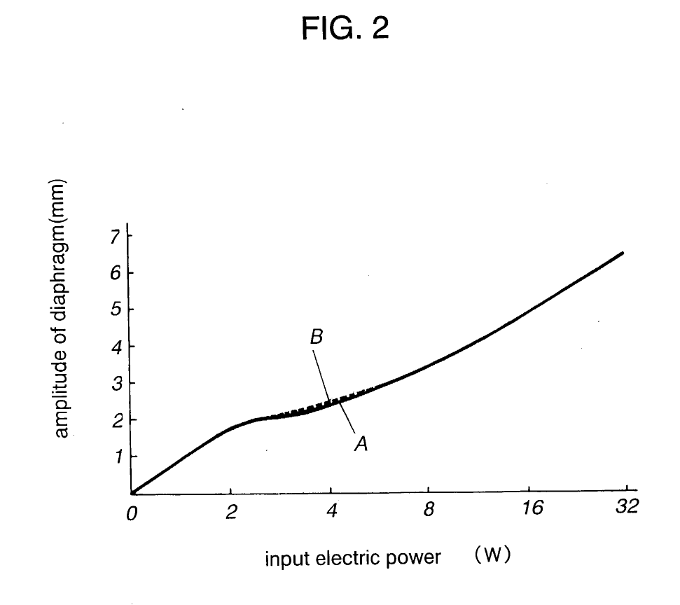

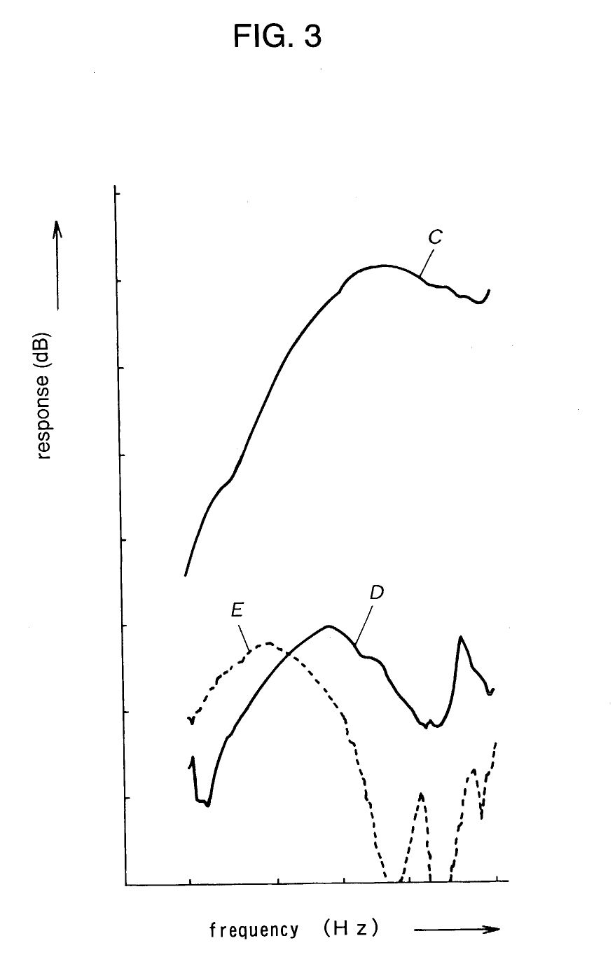

First edge 18 is protruded toward an opposite side of magnetic circuit 9. Second edge 21 is protruded toward magnetic circuit 9, where first edge 18 and second edge 21 are substantially symmetrical analog each other about a median of first edge 18 and second edge 21. FIG. 2 is a graph showing a characteristic of power linearity of the loudspeaker in accordance with the first embodiment of the invention, namely amplitude of diaphragm 17 vs. input electric power. Solid line A shows a characteristic of input electric power vs. diaphragm amplitude toward magnetic circuit 9, and broken line B shows a characteristic of input electric power vs. diaphragm amplitude toward the opposite side of magnetic circuit 9. FIG. 3 is a graph showing a characteristic of harmonic distortion of the loudspeaker in accordance with the first embodiment of the invention, and shows that as a dynamic range of output sound pressure and harmonic distortion becomes larger, harmonic distortion becomes smaller. Curve C shows output sound pressure, curve D shows the second harmonic distortion characteristic and curve E shows the third harmonic distortion characteristic.

Workings of the loudspeaker, whose construction is discussed above, are described hereinafter.

An electric signal, which is supplied from an audio amplifier and the like, is input to coil 16 of voice coil member 15, and voice coil member 15 is excited. As a result, force is transmitted to diaphragm 17, then diaphragm 17 vibrates air, thereby changing the electric signal into voice.

Instead of a conventional damper, a suspension formed of suspension holder 20 and second edge 21 is provided between voice coil member 15 and frame 19. Suspension holder 20, second edge 21 and first edge 18 form a suspension, which prevents voice coil member 15 from rolling in working. First edge 18 and second edge 21 form the suspension, so that a damper causing non-linearity and asymmetry is not needed. First edge 18 and second edge 21 are substantially symmetrical analog each other for canceling their own asymmetry. First edge 18 and second edge 21 are protruded in an opposite direction each other. As a result, as shown in the characteristic of input electric power vs. diaphragm amplitude of power linearity indicated by solid line A and broken line B of FIG. 2, non-linearity and asymmetry of the suspension can be solved.

Besides, as shown in the harmonic distortion characteristic of the loudspeaker indicated by curve D and curve E of FIG. 3, the harmonic distortion caused by non-linearity and asymmetry is reduced, so that a high efficiency loudspeaker can be obtained. Diaphragm 17 is not limited to an substantially inverted cone shape, and the same effect can be obtained using a flat shape.

### Second Exemplary Embodiment

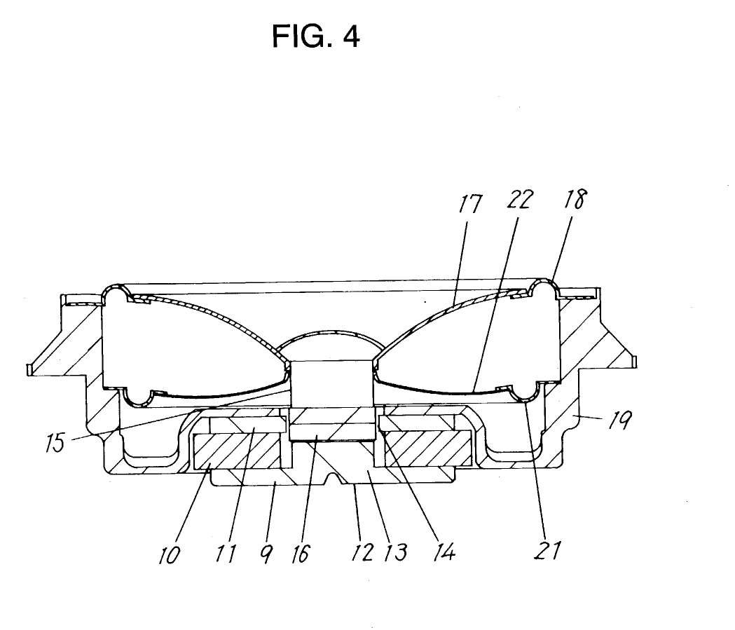

The second exemplary embodiment is demonstrated hereinafter with reference to FIG. 4. FIG. 4 is a sectional view of a loudspeaker in accordance with the second exemplary embodiment of the present invention. The same constituent elements as in the first exemplary embodiment are identified with the same reference numerals. In FIG. 4, an inner peripheral part of substantially cone shape suspension holder 22 is linked with voice coil member 15 at a linked position, which is nearer to magnetic circuit 9 than a linked position of diaphragm 17 and voice coil member 15. Suspension holder 22 and diaphragm 17 are substantially symmetrical analog each other about a median of suspension holder 22 and diaphragm 17. As a result, a long distance between a fulcrum of first edge 18 and a fulcrum of second edge 21 can be obtained, thereby preventing voice coil member 15 from rolling.

### Third Exemplary Embodiment

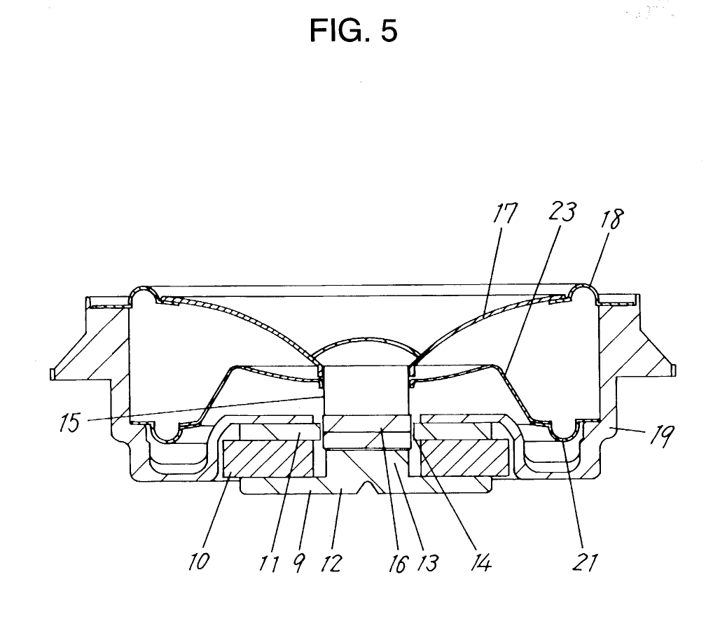

The third exemplary embodiment is demonstrated hereinafter with reference to FIG. 5. FIG. 5 is a sectional view of a loudspeaker in accordance with the third exemplary embodiment of the present invention. The same constituent elements as in the first and the second exemplary embodiments are identified with the same reference numbers. In FIG. 5, an inner peripheral part of suspension holder 23 is linked with voice coil member 15 at a linked position, which is nearer to magnetic circuit 9 than a linked position of diaphragm 17 and voice coil member 15. An outer peripheral part of suspension holder 23 is bent downward. As a result, distance between a fulcrum of first edge 18 and a fulcrum of second edge 21 is expanded maximally, thereby preventing voice coil member 15 from rolling.

### Fourth Exemplary Embodiment

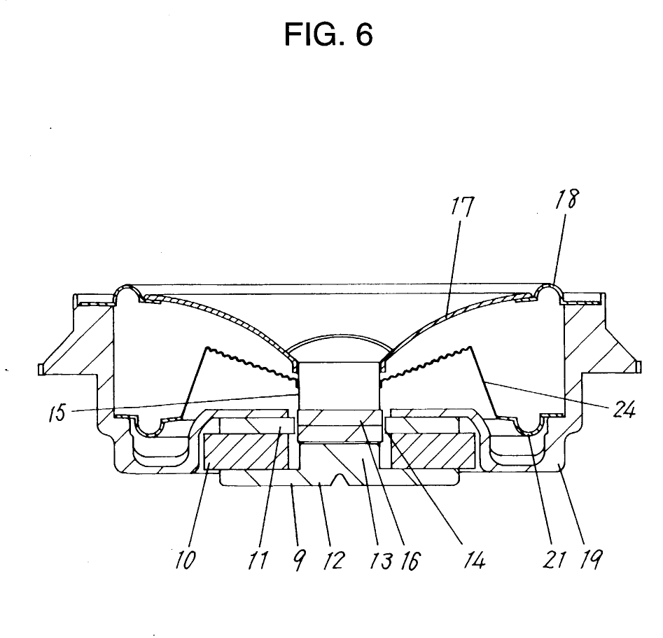

The fourth exemplary embodiment is demonstrated hereinafter with reference to FIG. 6. FIG. 6 is a sectional view of a loudspeaker in accordance with the fourth exemplary embodiment of the present invention. The same constituent elements as described in the first through the fifth exemplary embodiments are identified with the same reference numerals. In FIG. 6, an inner peripheral part of suspension holder 24 is linked with voice coil member 15 at a linked position, which is nearer to magnetic circuit 9 than a linked position of diaphragm 17 and voice coil member 15. An upper surface of suspension holder 24 has a corrugated shape. Using the structure discussed above, response to high acceleration which first edge 18 and second edge 21 can not follow is achieved, and resonance of a low- to middle-frequency ranges at a low amplitude is absorbed. As a result, a frequency characteristic is leveled, and resonance distortion is reduced.

### Fifth Exemplary Embodiment

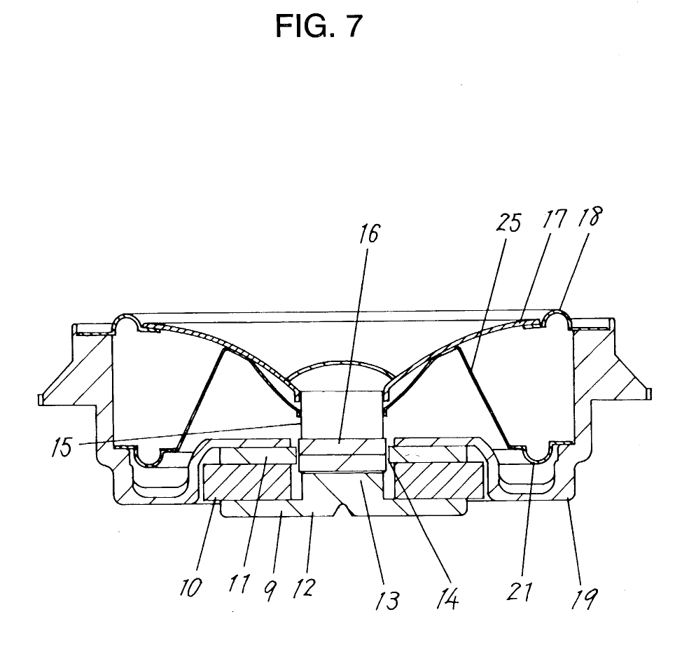

The fifth exemplary embodiment is demonstrated hereinafter with reference to FIG. 7. FIG. 7 is a sectional view of a loudspeaker in accordance with the fifth exemplary embodiment of the present invention. The same constituent elements as described in the first through the fourth exemplary embodiments are identified with the same reference numerals. In FIG. 7, an inner peripheral part of suspension holder 25 is linked with voice coil member 15 at a linked position, which is nearer to magnetic circuit 9 than a linked position of diaphragm 17 and voice coil member 15. A middle section between the inner peripheral part and an outer peripheral part of suspension holder 25 is coupled with a middle section of diaphragm 17 using an adhesive and the like. Using the structure discussed above, diaphragm 17 substantially has the same phase as suspension holder 25. As a result, resonance distortion, which is caused by a phase shift between diaphragm 17 and suspension holder 25, of a low- to middle-frequency ranges is reduced, and a frequency characteristic is leveled.

### Sixth Exemplary Embodiment

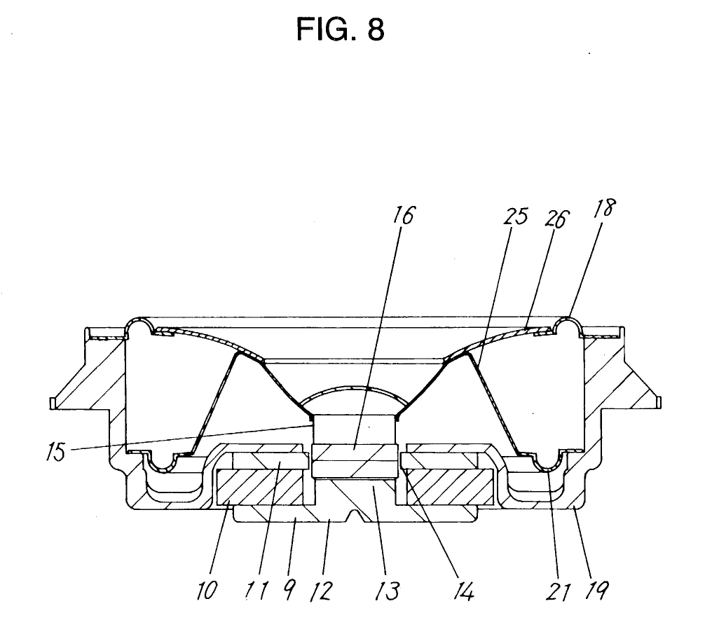

The sixth exemplary embodiment is demonstrated hereinafter with reference to FIG. 8. FIG. 8 is a sectional view of a loudspeaker in accordance with the sixth exemplary embodiment of the present invention. The same constituent elements as described in the first through the fifth exemplary embodiments are identified with the same reference numerals. In FIG. 8, an inner peripheral part of substantially inverted cone shape diaphragm 26 is linked with a middle section between an inner peripheral part and an outer peripheral part of suspension holder 25. An outer peripheral part of diaphragm 26 is linked with frame 19 via first edge 18. Using the structure discussed above, diaphragm 26 becomes much lighter, so that sound conversion efficiency of the loudspeaker is improved.

### Seventh Exemplary Embodiment

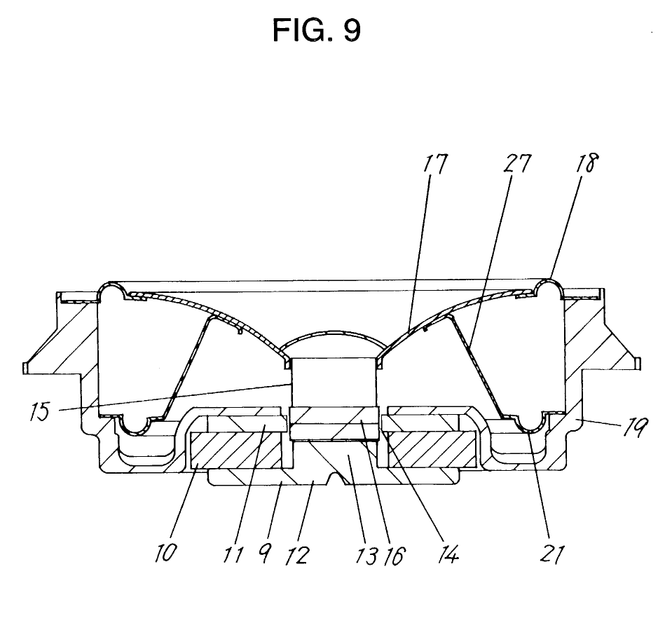

The seventh exemplary embodiment is demonstrated hereinafter with reference to FIG. 9. FIG. 9 is a sectional view of a loudspeaker in accordance with the seventh exemplary embodiment of the present invention. The same constituent elements as described in the first through the sixth exemplary embodiments are identified with the same reference numerals. In FIG. 9, an inner peripheral part of cone shape suspension holder 27 is linked with a middle section between an inner peripheral part and an outer peripheral part of diaphragm 17. An outer peripheral part of suspension holder 27 is linked with frame 19 via second edge 21. Using the structure discussed above, suspension holder 27 becomes much lighter, so that sound conversion efficiency of the loudspeaker is improved.

### Eighth Exemplary Embodiment

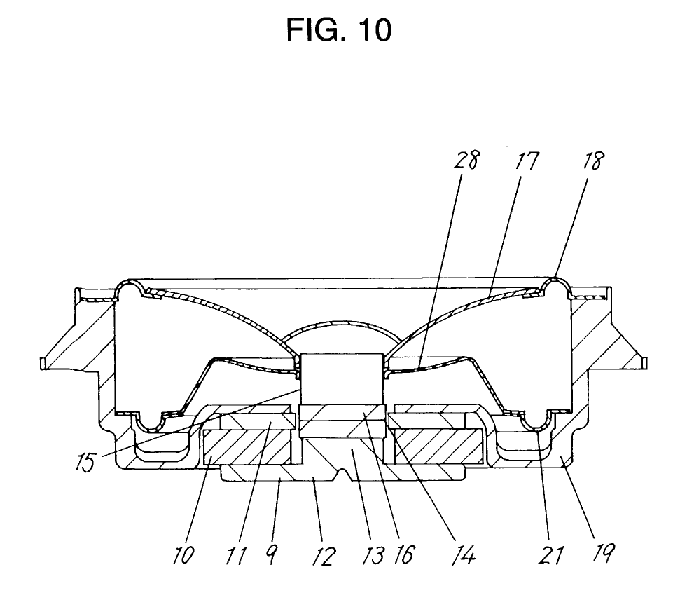

The eighth exemplary embodiment is demonstrated hereinafter with reference to FIG. 10. FIG. 10 is a sectional view of a loudspeaker in accordance with the eighth exemplary embodiment of the present invention. The same constituent elements as described in the first through the seventh exemplary embodiments are identified with the same reference numerals. In FIG. 10, metal material having high thermal conductivity is used for suspension holder 28 and a bobbin of voice coil member 15. Non-magnetic and light metal material such as aluminum is preferable.

Using the structure discussed above, heat generated from voice coil member 15 is dissipated efficiently in an atmosphere via the bobbin of voice coil member 15 and suspension holder 28, so that temperature rise of voice coil member 15 is restricted. As a result, even if an adhesive, whose adhesive strength weakens at a high temperature, is used, adhesive strength between diaphragm 17, suspension holder 28 and voice coil member 15 is secured enough, so that input durability of the loudspeaker are improved.

### Ninth Exemplary Embodiment

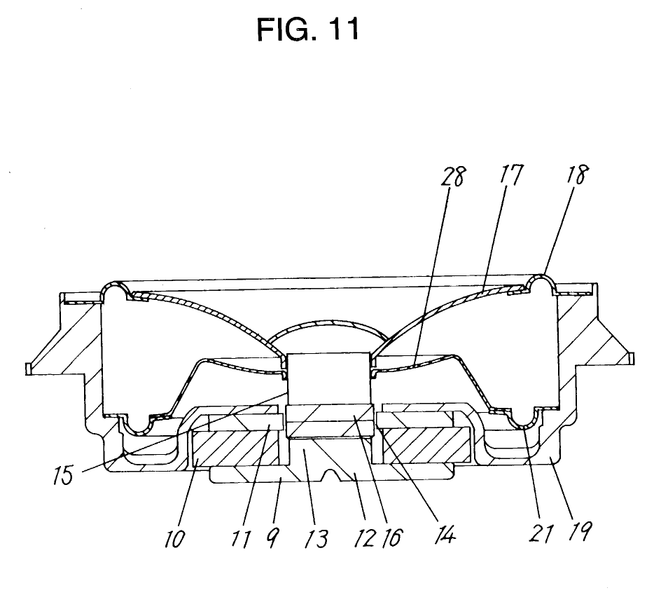

The ninth exemplary embodiment is demonstrated hereinafter with reference to FIG. 11. FIG. 11 is a sectional view of a loudspeaker in accordance with the ninth exemplary embodiment of the present invention. The same constituent elements as described in the first through the eighth exemplary embodiments are identified with the same reference numerals. In FIG. 11, first edge 18 is protruded toward an opposite side of magnetic circuit 9. Second edge 21 is protruded toward magnetic circuit 9.

Using the structure discussed above, even if first edge 18 is disposed near second edge 21, contact between first edge 18 and second edge 21 in working is avoided. As a result, maximum sound pressure becomes larger because large amplitude allowance of the loudspeaker can be obtained.

### Tenth Exemplary Embodiment

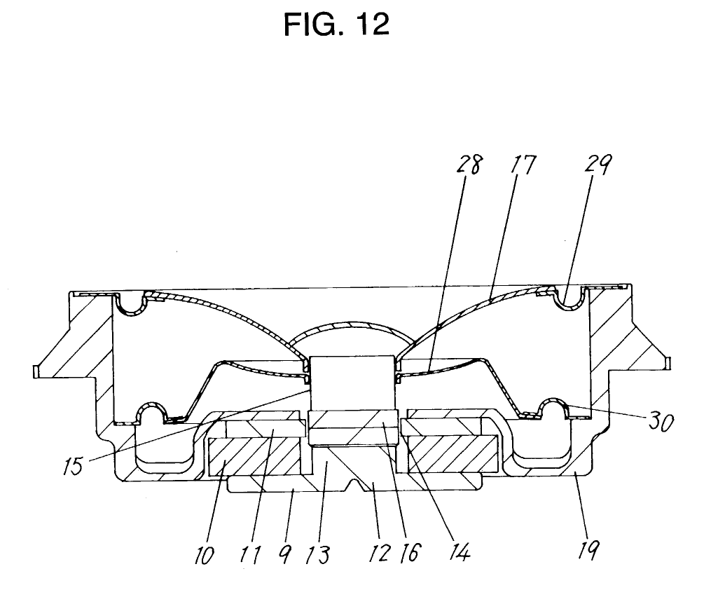

The tenth exemplary embodiment is demonstrated hereinafter with reference to FIG. 12. FIG. 12 is a sectional view of a loudspeaker in accordance with the tenth exemplary embodiment of the present invention. The same constituent elements as described in the first through the ninth exemplary embodiments are identified with the same reference numerals. In FIG. 12, first edge 29 is protruded toward magnetic circuit 9, and second edge 30 is protruded toward diaphragm 17.

Using the structure discussed above, even if a sound path opening such as a net is disposed adjacently in front of first edge 29, contact between first edge 29 and the net is avoided. As a result, maximum sound pressure becomes larger because large amplitude allowance of the loudspeaker can be obtained.

### Eleventh Exemplary Embodiment

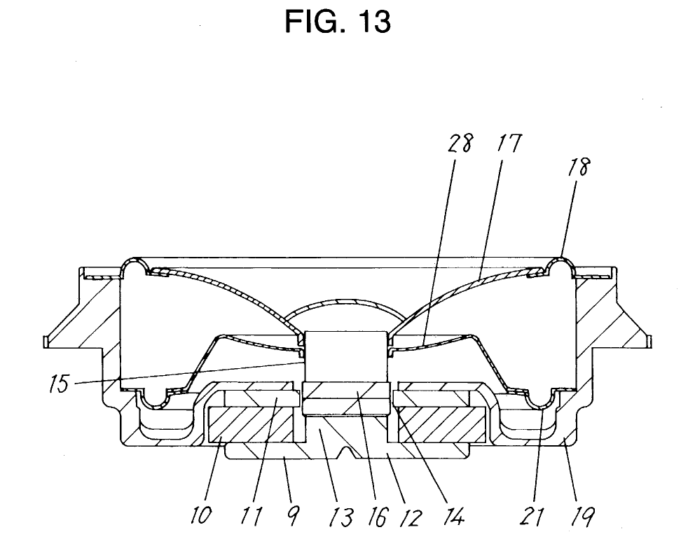

The eleventh exemplary embodiment is demonstrated hereinafter with reference to FIG. 13. FIG. 13 is a sectional view of a loudspeaker in accordance with the eleventh exemplary embodiment of the present invention. In FIG. 13, first edge 18 is substantially identical to second edge 21 in elastic coefficient.

Using the structure discussed above, first edge 18 and second edge 21 can cancel their own non-linearity and asymmetry exactly, so that harmonic distortion and power linearity, which is caused by non-linearity and asymmetry, of the loudspeaker is improved.

### Twelfth Exemplary Embodiment

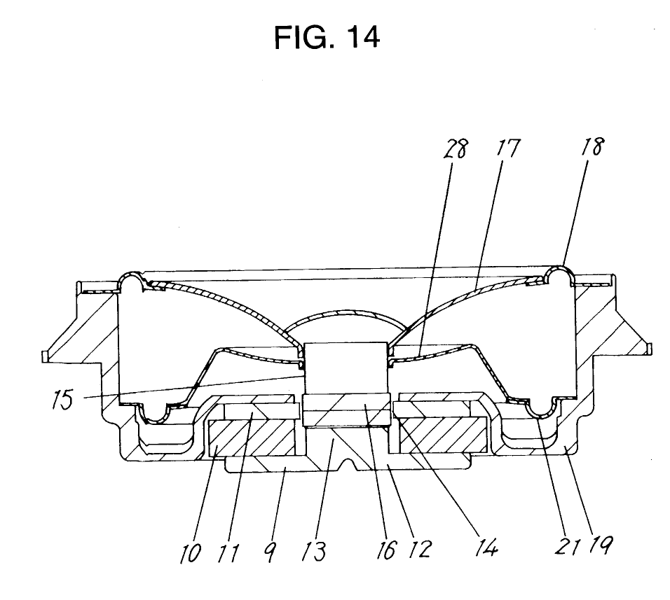

The twelfth exemplary embodiment is demonstrated hereinafter with reference to FIG. 14. FIG. 14 is a sectional view of a loudspeaker in accordance with the twelfth exemplary embodiment of the present invention. In FIG. 14, first edge 18 and second edge 21 are made of urethane.

Using the structure discussed above, the loudspeaker including first edge 18 and second edge 21 of this embodiment can reduce increasing rate of weight of vibration system. As a result, deterioration of efficiency due to increase of weight is prevented, because vibration system is light.

### Thirteenth Exemplary Embodiment

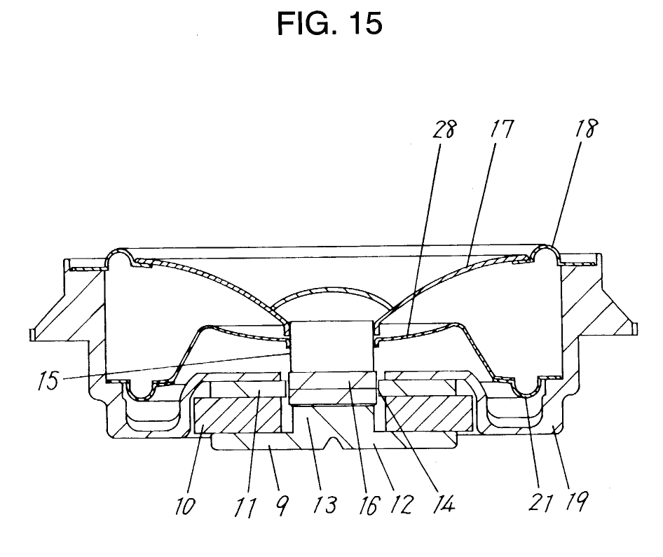

The thirteenth exemplary embodiment is demonstrated hereinafter with reference to FIG. 15. FIG. 15 is a sectional view of a loudspeaker in accordance with the thirteenth exemplary embodiment of the present invention. In FIG. 15, suspension holder 28 is made of pulp.

Using the structure discussed above, the loudspeaker can secure high elastic coefficient and large internal loss, and reduce weight of vibration system. As a result, even if loudspeaker becomes bigger, deterioration of efficiency is prevented, because vibration system is light.

### Fourteenth Exemplary Embodiment

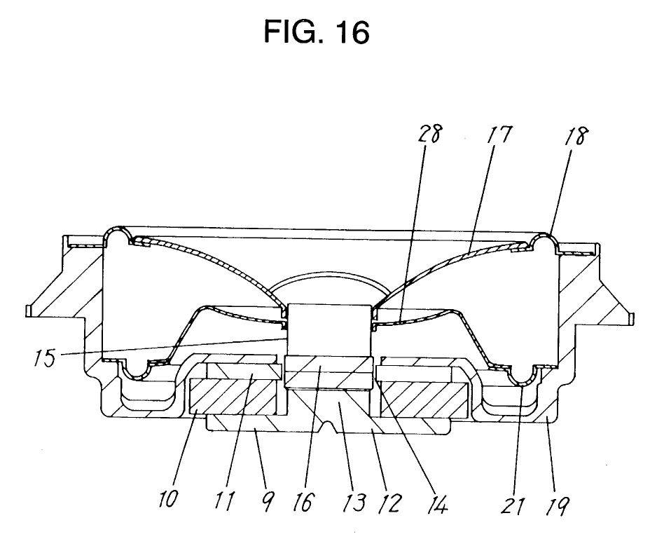

The fourteenth exemplary embodiment is demonstrated hereinafter with reference to FIG. 16. FIG. 16 is a sectional view of a loudspeaker in accordance with the fourteenth exemplary embodiment of the present invention. The same constituent elements as described in the first through the thirteenth exemplary embodiments are identified with the same reference numerals. In FIG. 16, an outer peripheral part of suspension holder 28 is placed nearer to magnetic circuit 9 than an inner peripheral part of frame 19, and linked with frame 19 via second edge 21. As a result, distance between a fulcrum of first edge 18 and a fulcrum of second edge 21 is expanded maximally, thereby preventing voice coil member 15 from rolling in working.

### Fifteenth Exemplary Embodiment

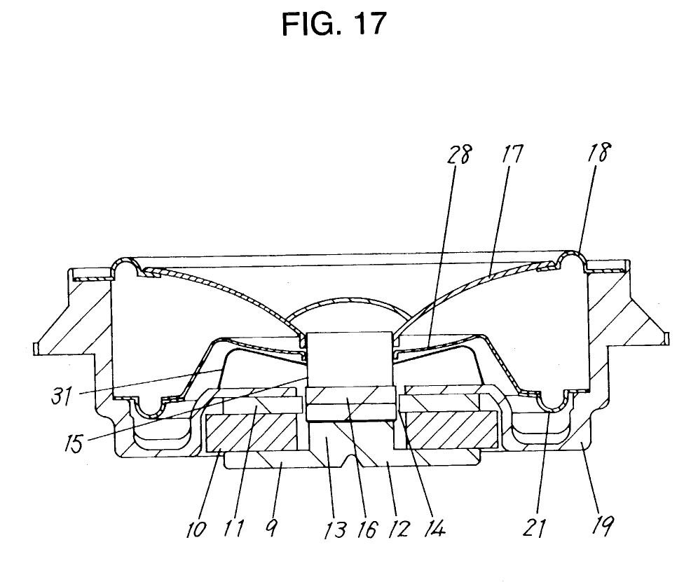

The fifteenth exemplary embodiment is demonstrated hereinafter with reference to FIG. 17. FIG. 17 is a sectional view of a loudspeaker in accordance with the fifteenth exemplary embodiment of the present invention. The same constituent elements as described in the first through the fourteenth exemplary embodiments are identified with the same reference numerals. In FIG. 17, dustproof net 31 is placed between voice coil member 15 and frame 19, thereby preventing dust and the like from entering into magnetic gap 14 of magnetic circuit 9.

### Sixteenth Exemplary Embodiment

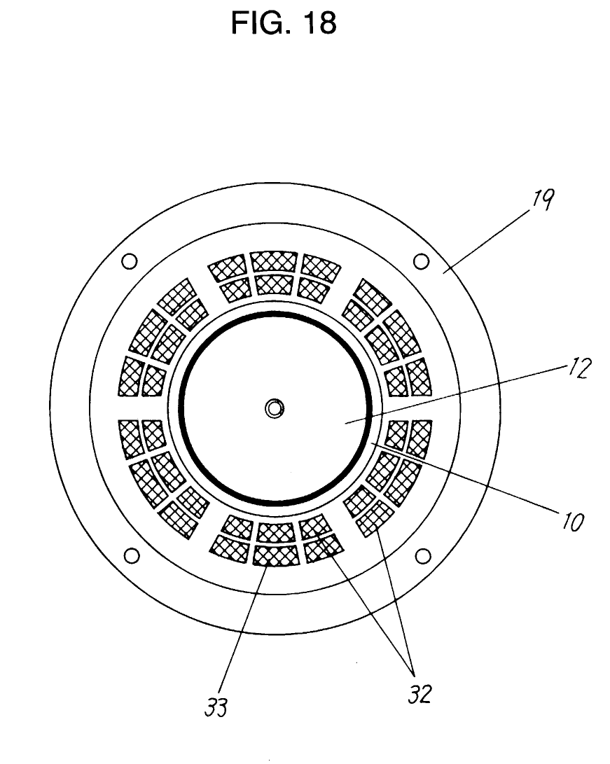

The sixteenth exemplary embodiment is demonstrated hereinafter with reference to FIG. 18. FIG. 18 is a rear view of a loudspeaker in accordance with the sixteenth exemplary embodiment of the present invention. The same constituent elements as described in the first through the fifteenth exemplary embodiments are identified with the same reference numerals. In FIG. 18, an inner end of frame 19 is linked with magnetic circuit 9, and an inner end section (bottom side) of frame 19 includes vent holes 32 having dustproof net 31, thereby preventing dust and the like from entering into magnetic gap 14 of magnetic circuit 9.

### Seventeenth Exemplary Embodiment

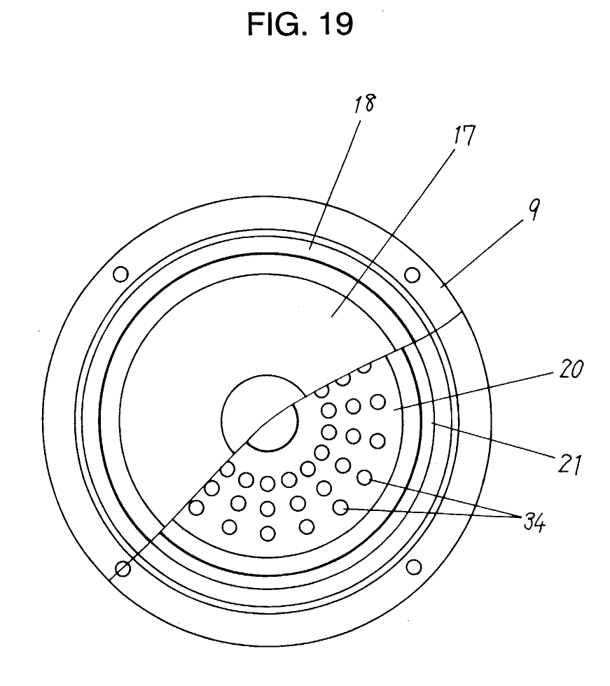

The seventeenth exemplary embodiment is demonstrated hereinafter with reference to FIG. 19. FIG. 19 is a partially cutaway front view of a loudspeaker in accordance with the seventeenth exemplary embodiment of the present invention. The same constituent elements as in the first exemplary embodiment are identified with the same reference numerals. In FIG. 19, openings 34 are formed at suspension holder 20. The structure mentioned above prevents a sound output of suspension holder 20 from interfering with diaphragm 17, thereby preventing deterioration of sound characteristics.

### Eighteenth Exemplary Embodiment

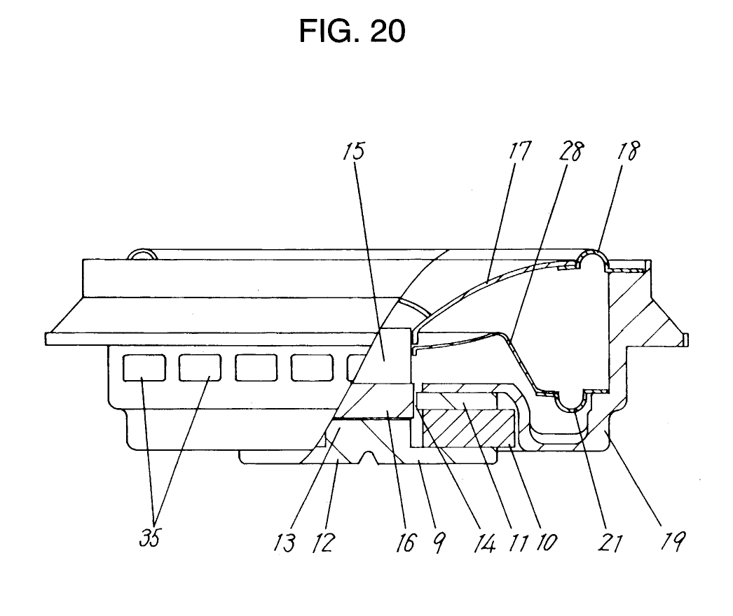

The eighteenth exemplary embodiment is demonstrated hereinafter with reference to FIG. 20. FIG. 20 is a partially cutaway sectional view of the loudspeaker in accordance with a eighteenth exemplary embodiment of the present invention. The same constituent elements as described in the first through the seventeenth exemplary embodiments are identified with the same reference numerals. In FIG. 20, between first edge 18 and second edge 21, openings 35 are formed at frame 19. The structure mentioned above prevents diaphragm 17, first edge 18, frame 19, second edge 21, suspension holder 28 and voice coil member 15 from forming an intermediate chamber. If the intermediate chamber is formed, a sound output of suspension holder 28 interferes with diaphragm 17, and sound characteristics deteriorate. Openings 35 prevent this deterioration.

### Nineteenth Exemplary Embodiment

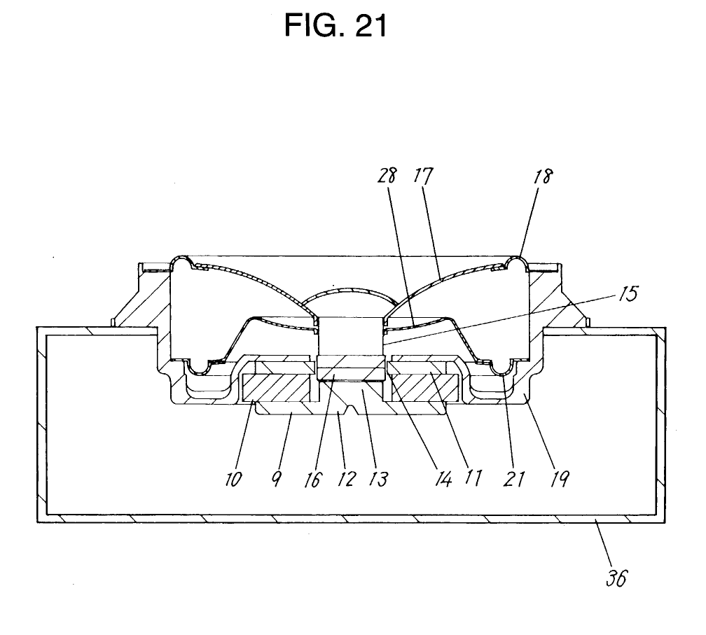

The nineteenth exemplary embodiment is demonstrated hereinafter with reference to FIG. 21. FIG. 21 is a sectional view of a loudspeaker in accordance with the nineteenth exemplary embodiment of the present invention. The same constituent elements as described in the first through the eighteenth exemplary embodiments are identified with the same reference numerals. In FIG. 21, cabinet 36, which is a rather small box, is fixed to the loudspeaker of the first through eighteenth embodiment of this invention, and an elastic coefficient of second edge 21 is larger than that of first edge 18.

Using the structure discussed above, even if the loudspeaker is used in the rather small cabinet 36, a suitable suspension characteristic can be obtained using an air cushion, first edge 18 and second edge 21. As a result, nonlinearity and asymmetry are canceled exactly, so that harmonic distortion of the loudspeaker is reduced and power linearity thereof is improved.

### INDUSTRIAL APPLICABILITY

As discussed above, in this invention, a loudspeaker forming a suspension by a first edge and a second edge can reduce harmonic distortion and improve power linearity, thereby increasing its performance.

### REFERENCE NUMERALS IN THE DRAWINGS

9 magnetic circuit

10 magnet

11 plate

12 yoke

13 pole

14 magnetic gap

15 voice coil member

16 coil

17, 26 diaphragm

18, 29 first edge

19 frame

20, 22, 23, 24, 25, 27, 28 suspension holder

21, 30 second edge

31, 33 dustproof net

32 vent hole

34, 35 opening

1. A loudspeaker comprising:
(a) a magnetic circuit including a magnetic gap;
(b) a voice coil member disposed in the magnetic gap of said magnetic circuit and having a movable coil;
(c) a diaphragm whose inner peripheral part is linked with said voice coil member, outside the magnetic gap;
(d) a frame linked with an outer peripheral part of said diaphragm via a first edge; and
(e) a suspension holder whose inner peripheral part is linked with said voice coil member at a linked position, which is nearer to said magnetic circuit than a linked position of said diaphragm and said voice coil member,
wherein an outer peripheral part of said suspension holder is linked with said frame via a second edge,
wherein the first edge and the second edge are substantially symmetrical analog each other about a median of the first edge and the second edge.

2. The loudspeaker of claim 1,
wherein a bobbin of said voice coil member and said suspension holder are made of metal.

3. The loudspeaker of claim 1,
wherein the first edge is protruded toward an opposite side of said magnetic circuit, and the second edge is protruded toward said magnetic circuit.

4. The loudspeaker of claim 1,
wherein the first edge is protruded toward said magnetic circuit, and the second edge is protruded toward said diaphragm.

5. The loudspeaker of claim 3,
wherein the first edge is substantially identical to the second edge in elastic coefficient.

6. The loudspeaker of claim 4,
wherein the first edge is substantially identical to the second edge in elastic coefficient.

7. The loudspeaker of claim 5,
wherein the first edge and the second edge are made of urethane.

8. The loudspeaker of claim 6,
wherein the first edge and the second edge are made of urethane.

9. The loudspeaker of claim 7,
wherein said suspension holder is made of pulp.

10. The loudspeaker of claim 8,
wherein said suspension holder is made of pulp.

11. The loudspeaker of claim 3,
wherein an outer peripheral part of said suspension holder is placed nearer to said magnetic circuit than an inner peripheral part of said frame, and linked with said frame via the second edge.

12. The loudspeaker of claim 4,
wherein an outer peripheral part of said suspension holder is placed nearer to said magnetic circuit than an inner peripheral part of said frame, and linked with said frame via the second edge.

13. The loudspeaker of claim 3,
wherein a dustproof net is placed between said suspension holder and said magnetic circuit.

14. The loudspeaker of claim 4,
wherein a dustproof net is placed between said suspension holder and said magnetic circuit.

15. The loudspeaker of claim 3,
wherein an inner end of said frame is linked with said magnetic circuit, and an inner end section of said frame includes a vent hole having a dustproof net.

16. The loudspeaker of claim 4,
wherein an inner end of said frame is linked with said magnetic circuit, and an inner end section of said frame includes a vent hole having a dustproof net.

17. The loudspeaker of claim 3,
wherein an opening is formed at said suspension holder.

18. The loudspeaker of claim 4,
wherein an opening is formed at said suspension holder.

19. The loudspeaker of claim 3,
wherein an opening is formed between the first edge and the second edge, at said frame.

20. The loudspeaker of claim 4,
wherein an opening is formed between the first edge and the second edge, at said frame.

21. The loudspeaker of claim 3,
wherein said magnetic circuit is covered with a cabinet at an opposite side of said diaphragm, and the second edge is larger than the first edge in elastic coefficient.

22. The loudspeaker of claim 4,
wherein said magnetic circuit is covered with a cabinet at an opposite side of said diaphragm, and the second edge is larger than the first edge in elastic coefficient.

23. A loudspeaker comprising:
(a) a magnetic circuit including a magnetic gap;
(b) a voice coil member disposed in the magnetic gap of said magnetic circuit and having a movable coil;
(c) a diaphragm whose inner peripheral part is linked with said voice coil member, outside the magnetic gap; and
(d) a frame linked with an outer peripheral part of said diaphragm via a first edge;
wherein an inner peripheral part of a suspension holder is linked with said voice coil member at a linked position, which is nearer to said magnetic circuit than a linked position of said diaphragm and said voice coil member,
wherein an outer peripheral part of said suspension holder is linked with said frame via a second edge,
wherein the first edge and the second edge are substantially symmetrical analog each other about a median of the first edge and the second edge,
wherein said diaphragm and said suspension holder are substantially symmetrical analog each other about a median of said diaphragm and said suspension holder.

24. The loudspeaker of claim 23,
wherein a bobbin of said voice coil member and said suspension holder are made of metal.

25. The loudspeaker of claim 23,
wherein the first edge is protruded toward an opposite side of said magnetic circuit, and the second edge is protruded toward said magnetic circuit.

26. The loudspeaker of claim 23,
wherein the first edge is protruded toward said magnetic circuit, and the second edge is protruded toward said diaphragm.

27. The loudspeaker of claim 25,
wherein the first edge is substantially identical to the second edge in elastic coefficient.

28. The loudspeaker of claim 26,
wherein the first edge is substantially identical to the second edge in elastic coefficient.

29. The loudspeaker of claim 27,
wherein the first edge and the second edge are made of urethane.

30. The loudspeaker of claim 28,
wherein the first edge and the second edge are made of urethane.

31. The loudspeaker of claim 29,
wherein said suspension holder is made of pulp.

32. The loudspeaker of claim 30,
wherein said suspension holder is made of pulp.

33. The loudspeaker of claim 25,
wherein an outer peripheral part of said suspension holder is placed nearer to said magnetic circuit than an inner peripheral part of said frame, and linked with said frame via the second edge.

34. The loudspeaker of claim 26,
wherein an outer peripheral part of said suspension holder is placed nearer to said magnetic circuit than an inner peripheral part of said frame, and linked with said frame via the second edge.

35. The loudspeaker of claim 25,
wherein a dustproof net is placed between said suspension holder and said magnetic circuit.

36. The loudspeaker of claim 26,
wherein a dustproof net is placed between said suspension holder and said magnetic circuit.

37. The loudspeaker of claim 25,
wherein an inner end of said frame is linked with said magnetic circuit, and an inner end section of said frame includes a vent hole having a dustproof net.

38. The loudspeaker of claim 26,
wherein an inner end of said frame is linked with said magnetic circuit, and an inner end section of said frame includes a vent hole having a dustproof net.

39. The loudspeaker of claim 25,
wherein an opening is formed at said suspension holder.

40. The loudspeaker of claim 26,
wherein an opening is formed at said suspension holder.

41. The loudspeaker of claim 25,
wherein an opening is formed between the first edge and the second edge, at said frame.

42. The loudspeaker of claim 26,
wherein an opening is formed between the first edge and the second edge, at said frame.

43. The loudspeaker of claim 25,
wherein said magnetic circuit is covered with a cabinet at an opposite side of said diaphragm, and the second edge is larger than the first edge in elastic coefficient.

44. The loudspeaker of claim 26,
wherein said magnetic circuit is covered with a cabinet at an opposite side of said diaphragm, and the second edge is larger than the first edge in elastic coefficient.

45. A loudspeaker comprising:
(a) a magnetic circuit including a magnetic gap;
(b) a voice coil member disposed in the magnetic gap of said magnetic circuit and having a movable coil;
(c) a diaphragm whose inner peripheral part is linked with said voice coil member, outside the magnetic gap; and
(d) a frame linked with an outer peripheral part of said diaphragm via a first edge;
wherein an inner peripheral part of a suspension holder is linked with said voice coil member at a linked position, which is nearer to said magnetic circuit than a linked position of said diaphragm and said voice coil member,
wherein an outer peripheral part of said suspension holder is linked with said frame via a second edge,
wherein the first edge and the second edge are substantially symmetrical analog each other about a median of the first edge and the second edge,
wherein an upper surface of said suspension holder has a corrugated shape.

46. The loudspeaker of claim 45,
wherein a bobbin of said voice coil member and said suspension holder are made of metal.

47. The loudspeaker of claim 45,
wherein the first edge is protruded toward an opposite side of said magnetic circuit, and the second edge is protruded toward said magnetic circuit.

48. The loudspeaker of claim 45,
wherein the first edge is protruded toward said magnetic circuit, and the second edge is protruded toward said diaphragm.

49. The loudspeaker of claim 47,
wherein the first edge is substantially identical to the second edge in elastic coefficient.

50. The loudspeaker of claim 48,
wherein the first edge is substantially identical to the second edge in elastic coefficient.

51. The loudspeaker of claim 47,
wherein the first edge and the second edge are made of urethane.

52. The loudspeaker of claim 48,
wherein the first edge and the second edge are made of urethane.

53. The loudspeaker of claim 51,
wherein said suspension holder is made of pulp.

54. The loudspeaker of claim 52,
wherein said suspension holder is made of pulp.

55. The loudspeaker of claim 47,
wherein an outer peripheral part of said suspension holder is placed nearer to said magnetic circuit than an inner peripheral part of said frame, and linked with said frame via the second edge.

56. The loudspeaker of claim 48,
wherein an outer peripheral part of said suspension holder is placed nearer to said magnetic circuit than an inner peripheral part of said frame, and linked with said frame via the second edge.

57. The loudspeaker of claim 47,
wherein a dustproof net is placed between said suspension holder and said magnetic circuit.

58. The loudspeaker of claim 48,
wherein a dustproof net is placed between said suspension holder and said magnetic circuit.

59. The loudspeaker of claim 47,
wherein an inner end of said frame is linked with said magnetic circuit, and an inner end section of said frame includes a vent hole having a dustproof net.

60. The loudspeaker of claim 48,
wherein an inner end of said frame is linked with said magnetic circuit, and an inner end section of said frame includes a vent hole having a dustproof net.

61. The loudspeaker of claim 47,
wherein an opening is formed at said suspension holder.

62. The loudspeaker of claim 48,
wherein an opening is formed at said suspension holder.

63. The loudspeaker of claim 47,
wherein an opening is formed between the first edge and the second edge, at said frame.

64. The loudspeaker of claim 48,
wherein an opening is formed between the first edge and the second edge, at said frame.

65. The loudspeaker of claim 46,
wherein said magnetic circuit is covered with a cabinet at an opposite side of said diaphragm, and the second edge is larger than the first edge in elastic coefficient.

66. The loudspeaker of claim 47,
wherein said magnetic circuit is covered with a cabinet at an opposite side of said diaphragm, and the second edge is larger than the first edge in elastic coefficient.

67. The loudspeaker of claim 48,
wherein said magnetic circuit is covered with a cabinet at an opposite side of said diaphragm, and the second edge is larger than the first edge in elastic coefficient.

68. A loudspeaker comprising:
(a) a magnetic circuit including a magnetic gap;
(b) a voice coil member disposed in the magnetic gap of said magnetic circuit and having a movable coil;
(c) a diaphragm whose inner peripheral part is linked with said voice coil member, outside the magnetic gap; and
(d) a frame linked with an outer peripheral part of said diaphragm via a first edge;
wherein an inner peripheral part of a suspension holder is linked with said voice coil member at a linked position, which is nearer to said magnetic circuit than a linked position of said diaphragm and said voice coil member,
wherein an outer peripheral part of said suspension holder is linked with said frame via a second edge,
wherein the first edge and the second edge are substantially symmetrical analog each other about a median of the first edge and the second edge,
wherein a middle section of said suspension holder is coupled with a middle section of said diaphragm.

69. The loudspeaker of claim 68,
wherein a bobbin of said voice coil member and said suspension holder are made of metal.

70. The loudspeaker of claim 68,
wherein the first edge is protruded toward an opposite side of said magnetic circuit, and the second edge is protruded toward said magnetic circuit.

71. The loudspeaker of claim 68,
wherein the first edge is protruded toward said magnetic circuit, and the second edge is protruded toward said diaphragm.

72. The loudspeaker of claim 70,
wherein the first edge is substantially identical to the second edge in elastic coefficient.

73. The loudspeaker of claim 71,
wherein the first edge is substantially identical to the second edge in elastic coefficient.

74. The loudspeaker of claim 72,
wherein the first edge and the second edge are made of urethane.

75. The loudspeaker of claim 73,
wherein the first edge and the second edge are made of urethane.

76. The loudspeaker of claim 74,
wherein said suspension holder is made of pulp.

77. The loudspeaker of claim 75,
wherein said suspension holder is made of pulp.

78. The loudspeaker of claim 70,
wherein an outer peripheral part of said suspension holder is placed nearer to said magnetic circuit than an inner peripheral part of said frame, and linked with said frame via the second edge.

79. The loudspeaker of claim 71,
wherein an outer peripheral part of said suspension holder is placed nearer to said magnetic circuit than an inner peripheral part of said frame, and linked with said frame via the second edge.

80. The loudspeaker of claim 70,
wherein a dustproof net is placed between said suspension holder and said magnetic circuit.

81. The loudspeaker of claim 71,
wherein a dustproof net is placed between said suspension holder and said magnetic circuit.

82. The loudspeaker of claim 70,
wherein an inner end of said frame is linked with said magnetic circuit, and an inner end section of said frame includes a vent hole having a dustproof net.

83. The loudspeaker of claim 71,
wherein an inner end of said frame is linked with said magnetic circuit, and an inner end section of said frame includes a vent hole having a dustproof net.

84. The loudspeaker of claim 70,
wherein an opening is formed at said suspension holder.

85. The loudspeaker of claim 71,
wherein an opening is formed at said suspension holder.

86. The loudspeaker of claim 70,
wherein an opening is formed between the first edge and the second edge, at said frame.

87. The loudspeaker of claim 71,
wherein an opening is formed between the first edge and the second edge, at said frame.

88. The loudspeaker of claim 69,
wherein said magnetic circuit is covered with a cabinet at an opposite side of said diaphragm, and the second edge is larger than the first edge in elastic coefficient.

89. The loudspeaker of claim 70,
wherein said magnetic circuit is covered with a cabinet at an opposite side of said diaphragm, and the second edge is larger than the first edge in elastic coefficient.

90. The loudspeaker of claim 71,
wherein said magnetic circuit is covered with a cabinet at an opposite side of said diaphragm, and the second edge is larger than the first edge in elastic coefficient.

91. A loudspeaker comprising:
(a) a magnetic circuit including a magnetic gap;
(b) a voice coil member disposed in the magnetic gap of said magnetic circuit and having a movable coil;
(c) a suspension whose inner peripheral part is linked with said voice coil member, outside the magnetic gap;
(d) a frame linked with an outer peripheral part of said suspension via a second edge; and
(e) a diaphragm whose inner peripheral part is linked with a middle section of said suspension holder, said diaphragm whose outer peripheral part is linked with said frame via a first edge;
wherein the first edge and the second edge are substantially symmetrical analog each other about a median of the first edge and the second edge.

92. The loudspeaker of claim 91,
wherein a bobbin of said voice coil member and said suspension holder are made of metal.

93. The loudspeaker of claim 91,
wherein the first edge is protruded toward an opposite side of said magnetic circuit, and the second edge is protruded toward said magnetic circuit.

94. The loudspeaker of claim 91,
wherein the first edge is protruded toward said magnetic circuit, and the second edge is protruded toward said diaphragm.

95. The loudspeaker of claim 93,
wherein the first edge is substantially identical to the second edge in elastic coefficient.

96. The loudspeaker of claim 94,
wherein the first edge is substantially identical to the second edge in elastic coefficient.

97. The loudspeaker of claim 93,
wherein the first edge and the second edge are made of urethane.

98. The loudspeaker of claim 94,
wherein the first edge and the second edge are made of urethane.

99. The loudspeaker of claim 93,
wherein said suspension holder is made of pulp.

100. The loudspeaker of claim 94,
wherein said suspension holder is made of pulp.

101. The loudspeaker of claim 93,
wherein an outer peripheral part of said suspension holder is placed nearer to said magnetic circuit than an inner peripheral part of said frame, and linked with said frame via the second edge.

102. The loudspeaker of claim 94,
wherein an outer peripheral part of said suspension holder is placed nearer to said magnetic circuit than an inner peripheral part of said frame, and linked with said frame via the second edge.

103. The loudspeaker of claim 93,
wherein a dustproof net is placed between said suspension holder and said magnetic circuit.

104. The loudspeaker of claim 94,
wherein a dustproof net is placed between said suspension holder and said magnetic circuit.

105. The loudspeaker of claim 93,
wherein an inner end of said frame is linked with said magnetic circuit, and an inner end section of said frame includes a vent hole having a dustproof net.

106. The loudspeaker of claim 94,
wherein an inner end of said frame is linked with said magnetic circuit, and an inner end section of said frame includes a vent hole having a dustproof net.

107. The loudspeaker of claim 93,
wherein an opening is formed at said suspension holder.

108. The loudspeaker of claim 94,
wherein an opening is formed at said suspension holder.

109. The loudspeaker of claim 93,
wherein an opening is formed between the first edge and the second edge, at said frame.

110. The loudspeaker of claim 94,
wherein an opening is formed between the first edge and the second edge, at said frame.

111. The loudspeaker of claim 92,
wherein said magnetic circuit is covered with a cabinet at an opposite side of said diaphragm, and the second edge is larger than the first edge in elastic coefficient.

112. The loudspeaker of claim 93,
wherein said magnetic circuit is covered with a cabinet at an opposite side of said diaphragm, and the second edge is larger than the first edge in elastic coefficient.

113. The loudspeaker of claim 94,
wherein said magnetic circuit is covered with a cabinet at an opposite side of said diaphragm, and the second edge is larger than the first edge in elastic coefficient.

114. A loudspeaker comprising:
(a) a magnetic circuit including a magnetic gap;
(b) a voice coil member disposed in the magnetic gap of said magnetic circuit and having a movable coil;
(c) a diaphragm whose inner peripheral part is linked with said voice coil member, outside the magnetic gap; and
(d) a frame linked with an outer peripheral part of said diaphragm via a first edge;
wherein an inner peripheral part of a suspension holder is linked with a middle section of said diaphragm,
wherein an outer peripheral part of said suspension holder is linked with said frame via a second edge,
wherein the first edge and the second edge are substantially symmetrical analog each other about a median of the first edge and the second edge.

115. The loudspeaker of claim 114,
wherein a bobbin of said voice coil member and said suspension holder are made of metal.

116. The loudspeaker of claim 114,
wherein the first edge is protruded toward an opposite side of said magnetic circuit, and the second edge is protruded toward said magnetic circuit.

117. The loudspeaker of claim 114,
wherein the first edge is protruded toward said magnetic circuit, and the second edge is protruded toward said diaphragm.

118. The loudspeaker of claim 116,
wherein the first edge is substantially identical to the second edge in elastic coefficient.

119. The loudspeaker of claim 117,
wherein the first edge is substantially identical to the second edge in elastic coefficient.

120. The loudspeaker of claim 116,
wherein the first edge and the second edge are made of urethane.

121. The loudspeaker of claim 117,
wherein the first edge and the second edge are made of urethane.

122. The loudspeaker of claim 116,
wherein said suspension holder is made of pulp.

123. The loudspeaker of claim 117,
wherein said suspension holder is made of pulp.

124. The loudspeaker of claim 116,
wherein an outer peripheral part of said suspension holder is placed nearer to said magnetic circuit than an inner peripheral part of said frame, and linked with said frame via the second edge.

125. The loudspeaker of claim 117,
wherein an outer peripheral part of said suspension holder is placed nearer to said magnetic circuit than an inner peripheral part of said frame, and linked with said frame via the second edge.

126. The loudspeaker of claim 116,
wherein a dustproof net is placed between said suspension holder and said magnetic circuit.

127. The loudspeaker of claim 117,
wherein a dustproof net is placed between said suspension holder and said magnetic circuit.

128. The loudspeaker of claim 116,
wherein an inner end of said frame is linked with said magnetic circuit, and an inner end section of said frame includes a vent hole having a dustproof net.

129. The loudspeaker of claim 117,
wherein an inner end of said frame is linked with said magnetic circuit, and an inner end section of said frame includes a vent hole having a dustproof net.

130. The loudspeaker of claim 116,
wherein an opening is formed at said suspension holder.

131. The loudspeaker of claim 117,
wherein an opening is formed at said suspension holder.

132. The loudspeaker of claim 116,
wherein an opening is formed between the first edge and the second edge, at said frame.

133. The loudspeaker of claim 117,
wherein an opening is formed between the first edge and the second edge, at said frame.

134. The loudspeaker of claim 115,
wherein said magnetic circuit is covered with a cabinet at an opposite side of said diaphragm, and the second edge is larger than the first edge in elastic coefficient.

135. The loudspeaker of claim 116,
wherein said magnetic circuit is covered with a cabinet at an opposite side of said diaphragm, and the second edge is larger than the first edge in elastic coefficient.

136. The loudspeaker of claim 117,
wherein said magnetic circuit is covered with a cabinet at an opposite side of said diaphragm, and the second edge is larger than the first edge in elastic coefficient.

137. A loudspeaker comprising:
(a) a magnetic circuit including a magnetic gap;
(b) a voice coil member disposed in the magnetic gap of said magnetic circuit and having a movable coil;
(c) a diaphragm whose inner peripheral part is linked with said voice coil member, outside the magnetic gap; and
(d) a frame linked with an outer peripheral part of said diaphragm via a first edge;
wherein an inner peripheral part of a suspension holder is linked with said voice coil member at a linked position, which is nearer to said magnetic circuit than a linked position of said diaphragm and said voice coil member,
wherein an outer peripheral part of said suspension holder is linked with said frame via a second edge,
wherein the first edge and the second edge are formed to cancel their own non-linearity.
